(19) United States
(12) Patent Application Publication
(10) Pub. No.: US 2024/0303774 A1
(43) Pub. Date: Sep. 12, 2024

(54) METHOD OF PROCESSING IMAGE, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Changyong SHU, Beijing (CN); Jiaming LIU, Beijing (CN); Zhibin HONG, Beijing (CN); Junyu HAN, Beijing (CN)

(73) Assignee: BEIJING BAIDU NETCOM SCIENCE TECHNOLOGY CO., LTD., Beijing (CN)

(21) Appl. No.: 18/020,918

(22) PCT Filed: Jun. 10, 2022
(86) PCT No.: PCT/CN2022/098246

§ 371 Date: Feb. 10, 2023

(30) Foreign Application Priority Data
Aug. 25, 2021 (CN) 202110985605.0

(51) Int. Cl. G06T 5/50; G06T 5/60; G06T 7/40; G06T 7/55; G06T 7/90; G06V 40/16

(52) U.S. Cl. CPC G06T 5/50; G06T 5/60; G06T 7/40; G06T 7/55; G06T 7/90; G06V 40/172; G06T 2207/10024; G06T 2207/20081; G06T 2207/20084; G06T 2207/20221; G06T 2207/30201

(57) ABSTRACT

A method of processing an image, an electronic device and a storage medium. The method includes: generating a to-be-processed image according to a first target image and a second target image, where an identity information of an object in the to-be-processed image is matched with an identity information of an object in the first target image; generating a set of disentangled images according to the second target image and the to-be-processed image, where the set of disentangled images includes a head-disentangled image and a disentangled repair image; and generating a fusion image according to the set of disentangled images, where an identity information and a texture information of an object in the fusion image are matched with the identity information and the texture information of the object in the to-be-processed image, respectively, and a to-be-repaired information related to the object in the fusion image is repaired.

This application claims priority to Chinese Patent Application No. 202110985605.0, filed on Aug. 25, 2021, the entire content of which is incorporated herein in its entirety by reference.

### TECHNICAL FIELD

The present disclosure relates to a field of an artificial intelligence technology, in particular to fields of a computer vision and deep learning technologies, which may be applied to scenes such as a face image processing, a face recognition, etc. More specifically, the present disclosure relates to a method and an apparatus of processing an image, an electronic device, and a storage medium.

### BACKGROUND

With a development of the Internet and a development of an artificial intelligence technology with a deep learning as a core, a computer vision technology has been widely applied in various fields.

Because an object may reflect an inner feeling and transmit a communication information through a rich facial expression and gesture, a study on a facial image of the object is one of important research contents in a field of computer vision. A related research on an image replacement technology of the facial image of the object combined with an image conversion also appears. An image replacement may be applied in many scenes, such as a film and television editing or a virtual character.

### SUMMARY

The present disclosure provides a method and an apparatus of processing an image, an electronic device, and a storage medium.

According to an aspect of the present disclosure, a method of processing an image is provided, including: generating a to-be-processed image according to a first target image and a second target image, where an identity information of an object in the to-be-processed image is matched with an identity information of an object in the first target image, and a texture information of the object in the to-be-processed image is matched with a texture information of an object in the second target image; generating a set of disentangled images according to the second target image and the to-be-processed image, where the set of disentangled images includes a head-disentangled image corresponding to a head region of the object in the to-be-processed image and a disentangled repair image corresponding to a to-be-repaired information related to the object in the to-be-processed image; and generating a fusion image according to the set of disentangled images, where an identity information of an object in the fusion image and a texture information of the object in the fusion image are matched with the identity information of the object in the to-be-processed image and the texture information of the object in the to-be-processed image, respectively, and a to-be-repaired information related to the object in the fusion image is repaired.

According to another aspect of the present disclosure, an apparatus of processing an image is provided, including: first generation module configured to generate a to-be-processed image according to a first target image and a second target image, where an identity information of an object in the to-be-processed image is matched with an identity information of an object in the first target image, and a texture information of the object in the to-be-processed image is matched with a texture information of an object in the second target image; a second generation module configured to generate a set of disentangled images according to the second target image and the to-be-processed image, where the set of disentangled images includes a head-disentangled image corresponding to a head region of the object in the to-be-processed image and a disentangled repair image corresponding to a to-be-repaired information related to the object in the to-be-processed image; and a third generation module configured to generate a fusion image according to the set of disentangled images, where an identity information of an object in the fusion image and a texture information of the object in the fusion image are matched with the identity information of the object in the to-be-processed image and the texture information of the object in the to-be-processed image, respectively, and a to-be-repaired information related to the object in the fusion image is repaired.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method as described above.

According to another aspect of the present disclosure, a non-transitory computer-readable storage medium having computer instructions therein is provided, and the computer instructions are configured to cause a computer to implement the method as described above.

According to another aspect of the present disclosure, a computer program product containing a computer program is provided, and the computer program, when executed by a processor, is configured to cause the processor to implement the method as described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 schematically shows an exemplary system architecture to which a method and an apparatus of processing an image may be applied according to embodiments of the present disclosure;

FIG. 2 schematically shows a flowchart of a method of processing an image according to embodiments of the present disclosure;

FIG. 3 schematically shows a schematic diagram of a process of generating a to-be-processed image according to embodiments of the present disclosure;

FIG. 4 schematically shows a process of processing an image according to embodiments of the present disclosure;

FIG. 5 schematically shows a block diagram of an apparatus of processing an image according to embodiments of the present disclosure; and

FIG. 6 schematically shows a block diagram of an electronic device suitable for implementing a method of processing an image according to embodiments of the present disclosure.

### DETAILED DESCRIPTION OF EMBODIMENTS

Exemplary embodiments of the present disclosure will be described below with reference to accompanying drawings, which include various details of the embodiments of the present disclosure to facilitate understanding and should be considered as merely exemplary. Therefore, those of ordinary skilled in the art should achieve that various changes and modifications may be made to embodiments described herein without departing from the scope and spirit of the present disclosure. Likewise, for clarity and conciseness, descriptions of well-known functions and structures are omitted in the following description.

In a process of achieving the concept of the present disclosure, it is found that an image replacement is achieved through a face replacement. That is, facial features are replaced, while other information other than a facial region is ignored, such as a head information and a skin color information, and the head information may include hair, a head shape, etc. Therefore, an identity similarity of a replaced image may be easily caused to be low, thereby affecting a replacement effect of the image replacement.

The low identity similarity of the replaced image that may be easily caused will be described through following examples. For example, a head region of an object a in an image A is needed to replace a head region of an object b in an image B. A skin color of the object b is black, and a skin color of the object a is yellow. If the facial features are replaced and the skin color information is ignored, a case that the facial features of the object in the replaced image are yellow and the skin color of the face is black may occur, so that the identity similarity of the replaced image is reduced.

Therefore, embodiments of the present disclosure propose a solution of a multi-stage head-change fusion to generate a fusion result with a high identity information similarity. The solution includes: generating a to-be-processed image according to a first target image and a second target image, generating a set of disentangled images according to the second target image and the to-be-processed image, and generating a fusion image according to the set of disentangled images, where an identity information of an object in the fusion image and a texture information of the object in the fusion image are matched with the identity information of the object in the to-be-processed image and the texture information of the object in the to-be-processed image, respectively, and a to-be-repaired information for the fusion image is repaired. As the to-be-repaired information related to the object in the fusion image has been repaired, an identity similarity of the fusion image may be improved, and the replacement effect of the image replacement may be improved.

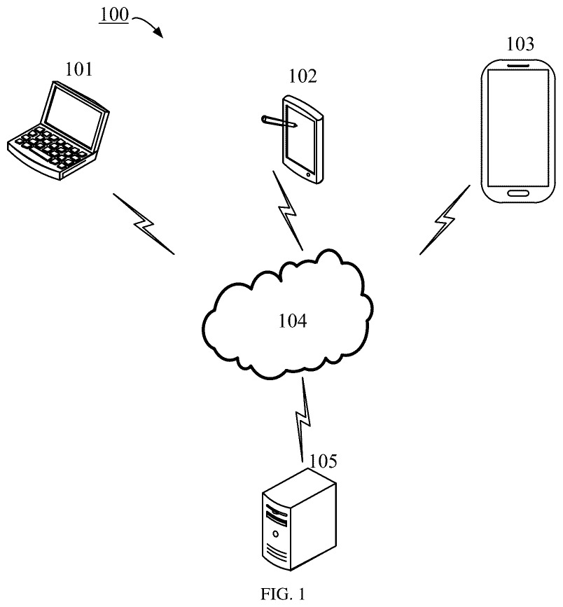

FIG. 1 schematically shows an exemplary system architecture to which a method and an apparatus of processing an image may be applied according to embodiments of the present disclosure.

It should be noted that FIG. 1 only shows an example of a system architecture to which embodiments of the present disclosure may be applied to help those skilled in the art understand the technical content of the present disclosure, but it does not mean that embodiments of the present disclosure may not be applied to other devices, systems, environments or scenarios. For example, in other embodiments, an exemplary system architecture to which the method and the apparatus of processing the image may be applied may include a terminal device, and the terminal device may implement the method and the apparatus of processing the image provided in embodiments of the present disclosure without interacting with a server.

As shown in FIG. 1, a system architecture 100 according to such embodiments may include terminal devices 101, 102, 103, a network 104 and a server 105. The network 104 is a medium used to provide a communication link between the terminal devices 101, 102, 103 and the server 105. The network 104 may include various connection types, such as wired and/or wireless communication links, etc.

The terminal devices 101, 102, 103 used by a user may interact with the server 105 via the network 104, so as to receive or send messages, etc. Various communication client applications may be installed on the terminal devices 101, 102, 103, such as knowledge reading applications, web browser applications, search applications, instant messaging tools, mailbox clients and/or social platform software, etc., (for example only).

The terminal devices 101, 102 and 103 may be various electronic devices having display screens and supporting web browsing, including but not limited to smartphones, tablet computers, laptop computers, desktop computers, etc.

The server 105 may be a server that provides various services, such as a background management server (for example only) that provides a support for a content browsed by the user using the terminal devices 101, 102, 103. The background management server may analyze and process a received user request and other data, and feed back a processing result (e.g., web page, information or data acquired or generated according to the user request) to the terminal devices.

The server 105 may be a cloud server, also known as cloud computing server or a cloud host, which is a host product in a cloud computing service system to solve shortcomings of difficult management and weak business scalability existing in an existing physical host and VPS (Virtual Private Server) service. The server 105 may also be a server of a distributed system, or a server combined with a block-chain.

It should be noted that the method of processing the image provided by embodiments of the present disclosure may generally be performed by the terminal device 101, 102, or 103. Accordingly, the apparatus of processing the image provided by embodiments of the present disclosure may also be provided in the terminal device 101, 102, or 103.

Alternatively, the method of processing the image provided by embodiments of the present disclosure may also be generally performed by the server 105. Accordingly, the apparatus of processing the image provided by embodiments of the present disclosure may generally be provided in the server 105. The method of processing the image provided by embodiments of the present disclosure may also be performed by a server or server cluster different from the server 105 and capable of communicating with the terminal devices 101, 102, 103 and/or the server 105. Accordingly, the apparatus of processing the image provided by embodiments of the present disclosure may also be provided in the server or server cluster different from the server 105 and capable of communicating with the terminal devices 101, 102, 103 and/or the server 105.

For example, the server 105 may be used to generate a to-be-processed image according to a first target image and a second target image, where an identity information of an object in the to-be-processed image is matched with an identity information of an object in the first target image, and a texture information of the object in the to-be-processed image is matched with a texture information of an object in the second target image, generate a set of disentangled images according to the second target image and the to-be-processed image, where the set of disentangled images includes a head-disentangled image corresponding to a head region of the object in the to-be-processed image and a disentangled repair image corresponding to a to-be-repaired information related to the object in the to-be-processed image, and generate a fusion image according to the set of disentangled images, where an identity information of an object in the fusion image and a texture information of the object in the fusion image are matched with the identity information of the object in the to-be-processed image and the texture information of the object in the to-be-processed image, respectively, and a to-be-repaired information related to the object in the fusion image is repaired. Alternatively, the server or server cluster capable of communicating with the terminal devices 101, 102, 103 and/or the server 105 may generate the to-be-processed image according to the first target image and the second target image, generate the set of disentangled images according to the second target image and the to-be-processed image, and generate the fusion image according to the set of disentangled images.

It should be understood that the numbers of terminal devices, network and server shown in FIG. 1 are only schematic. According to implementation needs, any number of terminal devices, networks and servers may be provided.

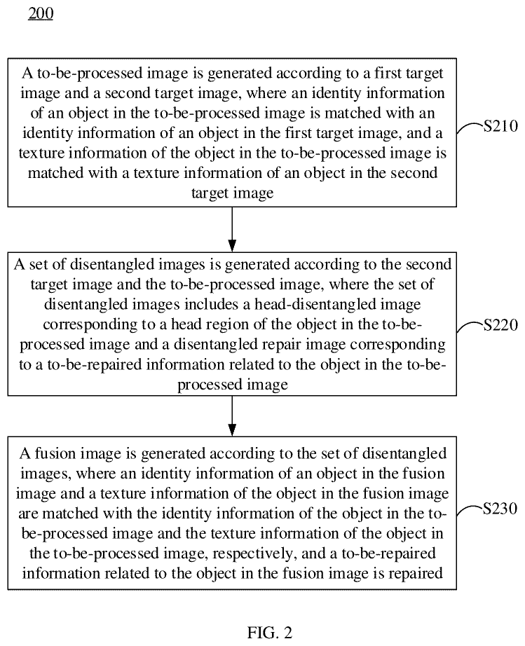

FIG. 2 schematically shows a flowchart of a method of processing an image according to embodiments of the present disclosure.

As shown in FIG. 2, a method 200 includes operations S210 to S230.

In operation S210, a to-be-processed image is generated according to a first target image and a second target image, where an identity information of an object in the to-be-processed image is matched with an identity information of an object in the first target image, and a texture information of the object in the to-be-processed image is matched with a texture information of an object in the second target image.

In operation S220, a set of disentangled images is generated according to the second target image and the to-be-processed image, where the set of disentangled images includes a head-disentangled image corresponding to a head region of the object in the to-be-processed image and a disentangled repair image corresponding to a to-be-repaired information related to the object in the to-be-processed image.

In operation S230, a fusion image is generated according to the set of disentangled images, where an identity information of an object in the fusion image and a texture information of the object in the fusion image are matched with the identity information of the object in the to-be-processed image and the texture information of the object in the to-be-processed image, respectively, and a to-be-repaired information related to the object in the fusion image is repaired.

According to embodiments of the present disclosure, the first target image may be understood as an image that provides an identity information of a first object, and the second target image may be understood as an image that provides a texture information of a second object. The texture information may include a facial texture information, and the facial texture information may include at least one of a facial pose information and a facial expression information. The object in the first target image may be understood as the first object, and the object in the second target image may be understood as the second object. If it is required to replace the texture information of the object in the first target image with the texture information of the object in the second target image, the first target image may be called as a driven image and the second target image may be called as a driving image.

According to embodiments of the present disclosure, a number of first target images may be one or more. The first target image may be a video frame in a video or a still image. The second target image may be a video frame in the video or a still image. For example, the number of the first target images may be multiple, and the identity information of objects in the multiple first target images is the same.

According to embodiments of the present disclosure, the to-be-processed image is an image in which the identity information of the object is consistent with the identity information of the object in the first target image, and the texture information of the object is consistent with the texture information of the object in the second target image, that is, the object in the to-be-processed image is the first object, and the texture information of the object in the to-be-processed image is the texture information of the second object.

According to embodiments of the present disclosure, the set of disentangled images may include the head-disentangled image and the disentangled repair image. The head-disentangled image may be understood as an image corresponding to the head region of the object in the to-be-processed image, that is, an image obtained by extracting relevant features of the head region of the object from the to-be-processed image. The disentangled repair image may be understood as an image including the to-be-repaired information related to the object in the to-be-processed image. The to-be-repaired information may include at least one of a skin color information and a missing information. The skin color information may include a facial skin color.

According to embodiments of the present disclosure, the fusion image may be understood as an image obtained after completing a repairing operation for the to-be-repaired information. The object in the fusion image is the same as the object in the to-be-processed image, that is, the identity information of the object in the fusion image is consistent with the identity information of the object in the to-be-processed image, and the texture information of the object in the fusion image is consistent with the texture information of the object in the to-be-processed image.

According to embodiments of the present disclosure, the first target image and the second target image may be acquired. The first target image and the second target image may be processed to obtain the to-be-processed image. The second target image and the to-be-processed image may be processed to obtain the set of disentangled images, and the set of disentangled images may be processed to obtain the fusion image. The processing the first target image and the second target image to obtain the to-be-processed image may include: extracting the identity information of the object from the first target image, extracting the texture information of the object from the second target image, and obtaining the to-be-processed image according to the identity information and the texture information.

According to embodiments of the present disclosure, the fusion image is generated according to the set of disentangled images. As the to-be-repaired information related to the object in the fusion image is repaired, an identity similarity of the fusion image may be improved, and a replacement effect of the image replacement may be improved.

According to embodiments of the present disclosure, the disentangled repair image includes a first disentangled image and a second disentangled image. An identity information of an object in the first disentangled image is matched with the identity information of the object in the to-be-processed image, and a skin color information of the object in the first disentangled image is matched with a skin color information of the object in the second target image. The second disentangled image is a differential image between the head region of the object in the to-be-processed image and a head region of the object in the second target image. The to-be-repaired information related to the object in the fusion image is repaired, indicating that: a skin color information of the object in the fusion image is matched with the skin color information of the object in the second target image, and a pixel value of a pixel in the differential image meets a preset condition.

According to embodiments of the present disclosure, in order to improve the replacement effect of the image replacement, it is required that a skin color information of the object in the to-be-processed image is consistent with the skin color information of the object in a driving image (that is, the second target image), and a missing region between the head region of the object in the to-be-processed image and the head region of the object in the second target image is repaired.

According to embodiments of the present disclosure, the first disentangled image may be used to align the skin color information of the object in the to-be-processed image with the skin color information of the object in the second target image. The first disentangled image may be a mask image of facial features with a color.

According to embodiments of the present disclosure, the second disentangled image may be used to repair the missing region between the head region of the object in the to-be-processed image and the head region of the object in the second target image. The second disentangled image may be understood as a differential image, and the differential image may be the differential image between the head region of the object in the to-be-processed image and the head region of the object in the second target image. The differential image may be a mask image.

According to embodiments of the present disclosure, the differential image includes a plurality of pixels, and each pixel has a pixel value corresponding to the pixel. A pixel value of a pixel point in the differential image meets the preset condition, which may include one of: a histogram distribution of a plurality of pixel values conforming to a preset histogram distribution, a standard deviation of the plurality of pixel values being less than or equal to a preset standard deviation threshold value, or a sum of the plurality of pixel values being less than or equal to a preset threshold value.

According to embodiments of the present disclosure, the head-disentangled image includes a third disentangled image, a fourth disentangled image and a fifth disentangled image. The third disentangled image includes a grayscale image of the head region of the object in the to-be-processed image. The fourth disentangled image includes a binarized image of the head region of the object in the to-be-processed image. The fifth disentangled image includes an image obtained according to the second target image and the fourth disentangled image.

According to embodiments of the present disclosure, the fourth disentangled image may include the binarized image of the head region of the object in the to-be-processed image, that is, a binarized mask image of a background and a foreground of the head region of the object in the to-be-processed image. The fifth disentangled image may be a differential image between the second target image and the fourth disentangled image. The fifth disentangled image may be understood as an image obtained by removing the head region of the object in the second target image and placing a head region of an object in the fourth disentangled image in a removed region.

According to embodiments of the present disclosure, the generating a set of disentangled images according to the second target image and the to-be-processed image may include: obtaining the first disentangled image according to the second target image and the to-be-processed image; obtaining the second disentangled image according to the second target image and the to-be-processed image; obtaining the third disentangled image according to the to-be-processed image; obtaining the fourth disentangled image according to the to-be-processed image; and obtaining the fifth disentangled image according to the second target image and the fourth disentangled image.

According to embodiments of the present disclosure, the generating a fusion image according to the set of disentangled images includes: processing the set of disentangled images by using a fusion model, so as to obtain the fusion image, where the fusion model includes a generator in a first generative adversarial network model.

According to embodiments of the present disclosure, the fusion model may be used to repair the to-be-repaired information, so that the fusion image obtained by using the fusion model and a background of a virtual character may be fused more naturally. The fusion model may be used to disentangle the skin color information of the object in the second target image, the head region of the object in the to-be-processed image, and a background information in the second target image, so as to achieve a skin color alignment and repair an image in the missing region. The skin color alignment is to change the skin color information of the object in the to-be-processed image to the skin color information of the object in the second target image. To repair the image in the missing region is to set a pixel value of a pixel in the differential image between the head region of the object in the to-be-processed image and the head region of the object in the second target image, so that the pixel value meets the preset condition.

According to embodiments of the present disclosure, the fusion model may be a model trained by using a deep learning. The fusion model may include the generator in the first generative adversarial network model, that is, the set of disentangled images is processed by using the generator in the first generative adversarial network model, so as to obtain the fusion model.

According to embodiments of the present disclosure, a generative adversarial network model may include a deep convolutional generative adversarial network model, an Earth Mover's distance-based generative adversarial network model, or a conditional generative adversarial network model, etc. The generative adversarial network model may include a generator and a discriminator. The generator and the discriminator may include a neural network model. The neural network model may include a Unet model. The Unet model may include two symmetrical portions, that is, a front portion of the model and a rear portion of the model. The front portion of the model is the same as a common convolutional network model, which includes a convolutional layer and a down-sampling layer, and may extract a context information (that is, a relationship between pixels) in an image. The rear portion of the model is substantially symmetrical with the front portion of the model, and the rear portion of the model includes a convolutional layer and an up-sampling layer, and may achieve a purpose of output image segmentation. In addition, the Unet model also makes use of a feature fusion, that is, a down-sampled feature of the front portion is fused with an up-sampled feature of the rear portion to obtain a more accurate context information and achieve a better segmentation effect.

According to embodiments of the present disclosure, the generator in the first generative adversarial network model may include the Unet model.

According to embodiments of the present disclosure, the fusion model may be trained by: acquiring a set of first sample images, where the set of first sample images includes a plurality of first sample images; processing each first sample image to obtain a set of sample disentangled images; training the first generative adversarial network model by using a plurality of sets of sample disentangled images, so as to obtain a trained first generative adversarial network model; and determining a generator in the trained first generative adversarial network model as the fusion model. The set of sample disentangled images may include a head-disentangled image corresponding to a head region of an object in the first sample image and a disentangled repair image corresponding to a to-be-repaired information related to the object in the first sample image.

According to embodiments of the present disclosure, the training the first generative adversarial network model by using a plurality of sets of sample disentangled images so as to obtain a trained first generative adversarial network model may include: processing each of the plurality of sets of sample disentangled images by using the generator in the first generative adversarial network model, so as to obtain a sample fusion image corresponding to each set of sample disentangled images; and alternately training the generator and the discriminator in the first generative adversarial network model according to a plurality of sample fusion images and the set of first sample images, so as to obtain the trained first generative adversarial network model.

According to embodiments of the present disclosure, the head-disentangled image corresponding to the head region of the object in the first sample image may include a first sample disentangled image and a second sample disentangled image. An identity information of an object in the first sample disentangled image corresponds to the identity information of the object in the first sample image, and a skin color information of the object in the first sample disentangled image corresponds to a preset skin color information. The second sample disentangled image is a differential image between the head region of the object in the first sample image and a preset head region.

According to embodiments of the present disclosure, the disentangled repair image corresponding to the to-be-repaired information related to the object in the first sample image may include a third sample disentangled image, a fourth sample disentangled image and a fifth sample disentangled image. The third sample disentangled image may include a grayscale image of the head region of the object in the first sample image. The fourth sample disentangled image may include a binarized image of the head region of the object in the first sample image. The fifth sample disentangled image may include an image obtained according to the fourth sample disentangled image.

According to embodiments of the present disclosure, the fusion model is trained by using a first identity information loss function, a first image feature alignment loss function, a first discriminant feature alignment loss function and a first discriminator loss function.

According to embodiments of the present disclosure, an identity information loss function may be used to achieve an alignment of the identity information. An image feature alignment loss function may be used to achieve an alignment of the texture information. A discriminant feature alignment loss function may be used to achieve an alignment of a texture information in a discriminator space as much as possible. A discriminator loss function may be used to ensure that a generated image has a high definition as much as possible.

According to embodiments of the present disclosure, the identity information loss function may be determined by the following equation (1):

$${L}_{ID} = {‖ Arcface ( Y ) - Arcface ( {X}_{ID} ) ‖}^{2} \qquad ( 1 )$$

In the equation, L_{ID} represents an identity loss function. Arcface(Y) represents an identity information of an object in the generated image. Arcface(X_{ID}) represents an identity information of an object in an original image.

The image feature alignment loss function may be determined by the following equation (2):

$${L}_{VGG} = {‖ VGG ( Y ) - VGG ( {X}_{pose} ) ‖}^{2} \qquad ( 2 )$$

In the equation, L_{VGG} represents the image feature alignment loss function. VGG(Y) represents a texture information of the object in the generated image. VGG(Xₚₒₛₑ) represents a texture information of the object in the original image.

The discriminant feature alignment loss function may be determined by the following equation (3):

$${L}_{D} = {‖ D ( Y ) - D ( {X}_{pose} ) ‖}^{2} \qquad ( 3 )$$

In the equation, L_{D} represents the discriminant feature alignment loss function. D(Y) represents a texture information of an object in a generated image in the discriminator space. D(Xₚₒₛₑ) represents a texture information of an object in an original image in the discriminator space.

The discriminator loss function may be determined by the following equation (4):

$${L}_{GAN} = E ( log D ( {X}_{pose} ) ) + E ( log ( 1 - D ( Y ) ) ) \qquad ( 4 )$$

In the equation, L_{VGG} represents the discriminator loss function.

According to embodiments of the present disclosure, the first identity information loss function may be used to achieve an alignment between an identity information of an object in the first sample image and an identity information of an object in the sample fusion image. The first image feature alignment loss function may be used to achieve an alignment between a texture information of the object in the first sample image and a texture information of the object in the sample fusion image. The first discriminant feature alignment loss function may be used to achieve an alignment between a texture information of the object in the first sample image in the discriminator space and a texture information of the object in the sample fusion image in the discriminator space. The first discriminator loss function may be used to ensure that the sample fusion image has a high definition as much as possible.

According to embodiments of the present disclosure, the generating a to-be-processed image according to a first target image and a second target image may include: processing the first target image by using an identity extraction module in a driving model, so as to obtain the identity information of the object in the first target image; processing the second target image by using a texture extraction module in the driving model, so as to obtain the texture information of the object in the second target image; processing the identity information and the texture information by using a concatenating module in the driving model, so as to obtain a concatenated information; and processing the concatenated information by using a generator in the driving model, so as to obtain the to-be-processed image.

According to embodiments of the present disclosure, the driving model may be used to disentangle the identity information of the object in the first target image and the texture information of the object in the second target image, so as to achieve a face replacement between the object in the first target image and the object in the second target image.

According to embodiments of the present disclosure, the driving model may include an identity extraction module, a texture extraction module, a concatenating module and a generator. The generator in the driving model may be a generator in a second generative adversarial network model. The identity extraction module may be used to extract the identity information of the object. The texture extraction module may be used to extract the texture information of the object. The concatenating module may be used to concatenate the identity information and the texture information. The generator in the driving model may be used to generate the fusion image according to the concatenated information.

According to embodiments of the present disclosure, the identity extraction module may be a first encoder, the texture extraction module may be a second encoder, and the concatenating module may be an MLP (Multilayer Perceptron). The first encoder and the second encoder may include a VGG (Visual Geometry Group) model.

According to embodiments of the present disclosure, a number of the concatenated information is multiple, and the generator in the driving model includes N depth units connected in cascade, where N is an integer greater than 1.

The processing the concatenated information by using a generator in the driving model so as to obtain the to-be-processed image may include: processing, for an i^{th} depth unit of the N depth units, an i^{th} level jump information corresponding to the i^{th} depth unit by using the i^{th} depth unit, so as to obtain an i^{th} level feature information, where the i^{th} level jump information includes an (i−1)^{th} level feature information and an i^{th} level concatenated information, and i is greater than 1 and less than or equal to N; and generating the to-be-processed image according to an N^{th} level feature information.

According to embodiments of the present disclosure, the generator in the driving model may include the N depth units connected in cascade. Each level of depth unit has a concatenated information corresponding to that level of depth unit. Different levels of depth units are used to extract features of an image at different depths. An input of each level of depth unit may include two portions, that is, a feature information corresponding to a previous level of depth unit of that level of depth unit and a concatenated information corresponding to that level of depth unit.

According to embodiments of the present disclosure, the driving model may be trained by: acquiring a set of second sample images and a set of third sample images, where the set of second sample images includes a plurality of second sample images, and the set of third sample images includes a plurality of third sample images; processing the second sample image by using the identity extraction module, so as to obtain an identity information of an object in the second sample image; processing the third sample image by using the texture extraction module, so as to obtain a texture information of an object in the third sample image; processing the identity information of the object in the second sample image and the texture information of the object in the third sample image by using the concatenating module, so as to obtain a sample concatenated information, and processing the sample concatenated information by using the generator, so as to obtain a simulated image; and training the identity extraction module, the texture extraction module, the concatenating module and the second generative adversarial network model by using the set of second sample images and a set of simulated images, so as to obtain a trained driving model.

According to embodiments of the present disclosure, the driving model is trained by using a second identity information loss function, a second target image feature alignment loss function, a second discriminant feature alignment loss function, a second discriminator loss function and a cycle consistency loss function.

According to embodiments of the present disclosure, the second identity information loss function may be used to achieve an alignment between an identity information of an object in the second sample image and an identity information of an object in the simulated image. The second image feature alignment loss function may be used to achieve an alignment between a texture information of the object in the second sample image and a texture information of the object in the simulated image. The second discriminant feature alignment loss function may be used to achieve an alignment between a texture information of the object in the second sample image in the discriminator space and a texture information of the object in the simulated image in the discriminator space. The second discriminator loss function may be used to ensure that the simulated image has a high definition as much as possible. The cycle consistent loss function may be used to improve an ability of the driving model to preserve the texture information of the object in the third sample image.

According to embodiments of the present disclosure, the cycle consistency loss function is determined according to a predicted result generated by the driving model and a real result. The real result includes a real identity information of an object in a real image and a real texture information of the object in the real image, and the predicted result includes a predicted identity information of an object in a simulated image and a predicted texture information of the object in the simulated image.

According to embodiments of the present disclosure, the real identity information of the object in the real image may be understood as the identity information of the object in the second sample image described above. The real texture information of the object in the real image may be understood as the texture information of the object in the third sample image described above.

According to embodiments of the present disclosure, the cycle consistent loss function may be determined by the following equations (5) to (7).

$$G ( {X}_{ID : ID 1} , {X}_{pose : pose 1} ) = {Y}_{ID : ID 1 \_ pose : pose 1} \qquad ( 5 )$$

In the equation, X_{ID:ID1} represents the identity information of the object in the second sample image. X_{pose:pose1} represents the texture information of the object in the third sample image. Y_{ID:ID1_pose:pose1} represents a first simulated image including the identity information of the object in the second sample image and the texture information of the object in the third sample image.

$$G ( {X}_{ID : pose 1} , {Y}_{pose : ID 1 \_ pose : pose 1} ) = {Y}_{ID : pose 1 \_ pose : pose 1} \qquad ( 6 )$$

In the equation, X_{ID:pose1} represents an identity information of the object in the third sample image. Y_{pose:ID1_pose:pose1} represents the texture information of the object in the third sample image. Y_{ID:pose1_pose:pose1} represents a second simulated image including the identity information of the object in the third sample image and the texture information of the object in the third sample image.

$${L}_{cycle =} {‖ {X}_{pose : pose 1} - {Y}_{ID : pose 1 \_ pose : pose 1} ‖}^{2} \qquad ( 7 )$$

In the equation, X_{pose:pose1} represents a real image corresponding to the object in the third sample image. Y_{ID:pose1_pose:pose1} represents the second simulated image.

According to embodiments of the present disclosure, the above-mentioned method of processing the image may further include: performing an enhancement processing on the fusion image to obtain an enhanced image.

According to embodiments of the present disclosure, in order to improve a definition of the fusion image, a definition enhancement processing may be performed on the fusion image to obtain the enhanced image, so that a definition of the enhanced image may be greater than the definition of the fusion image.

According to embodiments of the present disclosure, the performing an enhancement processing on the fusion image to obtain an enhanced image may include: processing the fusion image by using an enhancement model, so as to obtain the enhanced image, where the enhancement model includes a generator in a third generative adversarial network model.

According to embodiments of the present disclosure, the enhancement model may be used to improve the definition of the image. The enhancement model may include the generator in the third generative adversarial network model. The third generative adversarial network model may include PSFR (Progressive Semantic-Aware Style)-GAN.

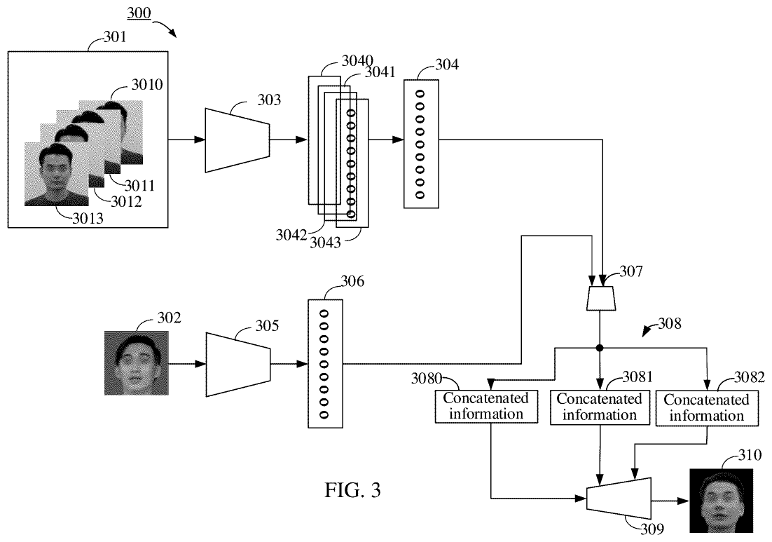

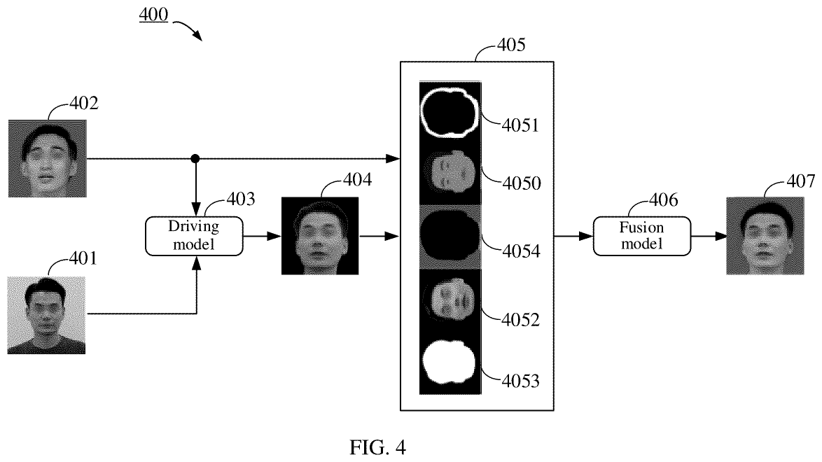

The method of processing the image according to embodiments of the present disclosure will be further described with reference to specific embodiments and FIG. 3 to FIG. 4.

FIG. 3 schematically shows a process of generating a to-be-processed image according to embodiments of the present disclosure.

As shown in FIG. 3, in a process 300, a set 301 of first target images includes a first target image 3010, a first target image 3011, a first target image 3012, and a first target image 3013. The driving model includes an identity extraction module 303, a texture extraction module 305, a concatenating module 307 and a generator 309.

The first target image set 301 is processed by using the identity extraction module 303, so as to obtain an identity information 3040 of an object in the first target image 3010, an identity information 3041 of an object in the first target image 3011, an identity information 3042 of an object in the first target image 3012, and an identity information 3043 of an object in the first target image 3013. An average identity information 304 is obtained according to the identity information 3040, the identity information 3041, the identity information 3042 and the identity information 3043, and the average identity information 304 is determined as the identity information 304 of the first target image.

A second target image 302 is processed by using the texture extraction module 305, so as to obtain a texture information 306 of an object in the first target image 302.

The identity information 304 and the texture information 306 are processed by using the concatenating module 307, so as to obtain a set 308 of concatenated information. The set 308 of concatenated information includes a concatenated information 3080, a concatenated information 3081 and a concatenated information 3082.

The set 308 of concatenated information is processed by using the generator 309, so as to obtain a to-be-processed image 310. An identity information of an object in the to-be-processed image 310 is matched with the identity information of the object in the first target image. A texture information of the object in the to-be-processed image 310 is matched with a texture information of an object in the second target image 302.

FIG. 4 schematically shows a process of processing an image according to embodiments of the present disclosure.

As shown in FIG. 4, in a process 400, a first target image 401 and a second target image 402 are processed by using a driving model 403, so as to obtain a to-be-processed image 404.

A first disentangled image 4050 in a set 405 of disentangled images is obtained according to the second target image 402 and the to-be-processed image 404. A second disentangled image 4051 in the set 405 of disentangled images is obtained according to the second target image 402 and the to-be-processed image 404. A third disentangled image 4052 in the set 405 of disentangled images is obtained according to the to-be-processed image 404. A fourth disentangled image 4053 in the set 405 of disentangled images is obtained according to the to-be-processed image 404. A fifth disentangled image 4054 in the set 405 of disentangled images is obtained according to the second target image 402 and the fourth disentangled image 4053.

The set 405 of disentangled images is processed by using a fusion model 406, so as to obtain a fusion image 407.

In the technical solution of the present disclosure, an acquisition, a storage, a use, a processing, a transmission, a provision, a disclosure and an application of user personal information involved comply with provisions of relevant laws and regulations, and do not violate public order and good custom.

In the technical solution of the present disclosure, a user's authorization or consent is acquired before the user personal information is acquired or collected.

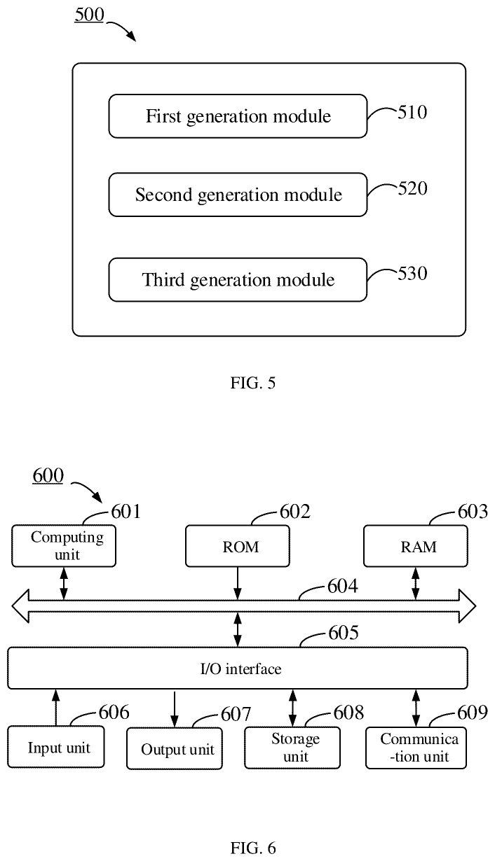

FIG. 5 schematically shows a block diagram of an apparatus of processing an image according to embodiments of the present disclosure.

As shown in FIG. 5, an apparatus 500 of processing an image may include a first generation module 510, a second generation module 520, and a third generation module 530.

The first generation module 510 is used to generate a to-be-processed image according to a first target image and a second target image, where an identity information of an object in the to-be-processed image is matched with an identity information of an object in the first target image, and a texture information of the object in the to-be-processed image is matched with a texture information of an object in the second target image.

The second generation module 520 is used to generate a set of disentangled images according to the second target image and the to-be-processed image, where the set of disentangled images includes a head-disentangled image corresponding to a head region of the object in the to-be-processed image and a disentangled repair image corresponding to a to-be-repaired information related to the object in the to-be-processed image.

The third generation module 530 is used to generate a fusion image according to the set of disentangled images, where an identity information of an object in the fusion image and a texture information of the object in the fusion image are matched with the identity information of the object in the to-be-processed image and the texture information of the object in the to-be-processed image, respectively, and a to-be-repaired information related to the object in the fusion image is repaired.

According to embodiments of the present disclosure, the disentangled repair image includes a first disentangled image and a second disentangled image. An identity information of an object in the first disentangled image is matched with the identity information of the object in the to-be-processed image, and a skin color information of the object in the first disentangled image is matched with a skin color information of the object in the second target image. The second disentangled image is a differential image between the head region of the object in the to-be-processed image and a head region of the object in the second target image. The to-be-repaired information related to the object in the fusion image is repaired, indicating that: a skin color information of the object in the fusion image is matched with the skin color information of the object in the second target image, and a pixel value of a pixel in the differential image meets a preset condition.

According to embodiments of the present disclosure, the head-disentangled image includes a third disentangled image, a fourth disentangled image and a fifth disentangled image. The third disentangled image includes a grayscale image of the head region of the object in the to-be-processed image. The fourth disentangled image includes a binarized image of the head region of the object in the to-be-processed image. The fifth disentangled image includes an image obtained according to the second target image and the fourth disentangled image.

According to embodiments of the present disclosure, the third generation module 530 may include a first processing unit.

The first processing unit is used to process the set of disentangled images by using a fusion model, so as to obtain the fusion image. The fusion model includes a generator in a first generative adversarial network model.

According to embodiments of the present disclosure, the fusion model is trained by using a first identity information loss function, a first image feature alignment loss function, a first discriminant feature alignment loss function and a first discriminator loss function.

According to embodiments of the present disclosure, the first generation module 510 may include a second processing unit, a third processing unit, a fourth processing unit and a fifth processing unit.

The second processing unit is used to process the first target image by using an identity extraction module in a driving model, so as to obtain the identity information of the object in the first target image.

The third processing unit is used to process the second target image by using a texture extraction module in the driving model, so as to obtain the texture information of the object in the second target image.

The fourth processing unit is used to process the identity information and the texture information by using a concatenating module in the driving model, so as to obtain a concatenated information.

The fifth processing unit is used to process the concatenated information by using a generator in the driving model, so as to obtain the to-be-processed image.

According to embodiments of the present disclosure, a number of the concatenated information is multiple, and the driving model includes N depth units connected in cascade, where N is an integer greater than 1.

The fifth processing unit may include a processing sub unit and a generation sub unit.

The processing sub unit is used to process, for an i^{th} depth unit of the N depth units, an i^{th} level jump information corresponding to the i^{th} depth unit by using the i^{th} depth unit, so as to obtain an i^{th} level feature information. The i^{th} level jump information includes an (i−1)^{th} level feature information and an i^{th} level concatenated information, where i is greater than 1 and less than or equal to N.

The generation sub unit is used to generate the to-be-processed image according to an N^{th} level feature information.

According to embodiments of the present disclosure, the driving model is trained by using a second identity information loss function, a second image feature alignment loss function, a second discriminant feature alignment loss function, a second discriminator loss function and a cycle consistency loss function.

According to embodiments of the present disclosure, the cycle consistency loss function is determined according to a predicted result generated by the driving model and a real result. The real result includes a real identity information of an object in a real image and a real texture information of the object in the real image, and the predicted result includes a predicted identity information of an object in a simulated image and a predicted texture information of the object in the simulated image.

According to embodiments of the present disclosure, the above-mentioned apparatus 500 of processing the image may further include a processing module.

The processing module is used to perform an enhancement processing on the fusion image to obtain an enhanced image.

According to embodiments of the present disclosure, the present disclosure further provides an electronic device, a readable storage medium and a computer program product.

According to embodiments of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method of processing the image as described above.

According to embodiments of the present disclosure, a non-transitory computer-readable storage medium having computer instructions therein is provided, where the computer instructions are configured to cause a computer to implement the method of processing the image as described above.

According to embodiments of the present disclosure, a computer program product containing a computer program, where the computer program, when executed by a processor, is configured to cause the processor to implement the method of processing the image as described above.

According to embodiments of the present disclosure, the present disclosure further provides an electronic device, a readable storage medium and a computer program product.

According to embodiments of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method as described above.

According to embodiments of the present disclosure, a non-transitory computer-readable storage medium having computer instructions therein is provided, wherein the computer instructions are configured to cause a computer to implement the method as described above.

According to embodiments of the present disclosure, a computer program product containing a computer program, where the computer program, when executed by a processor, is configured to cause the processor to implement the method as described above.

FIG. 6 schematically shows a block diagram of an electronic device suitable for implementing a method of processing an image according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, an electronic device 600 includes a computing unit 601 which may perform various appropriate actions and processes according to a computer program stored in a read only memory (ROM) 602 or a computer program loaded from a storage unit 608 into a random access memory (RAM) 603. In the RAM 603, various programs and data necessary for an operation of the electronic device 600 may also be stored. The computing unit 601, the ROM 602 and the RAM 603 are connected to each other through a bus 604. An input/output (I/O) interface 605 is also connected to the bus 604.

A plurality of components in the electronic device 600 are connected to the I/O interface 605, including: an input unit 606, such as a keyboard, or a mouse; an output unit 607, such as displays or speakers of various types; a storage unit 608, such as a disk, or an optical disc; and a communication unit 609, such as a network card, a modem, or a wireless communication transceiver. The communication unit 609 allows the electronic device 600 to exchange information/data with other devices through a computer network such as Internet and/or various telecommunication networks.

The computing unit 601 may be various general-purpose and/or dedicated processing assemblies having processing and computing capabilities. Some examples of the computing units 601 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 601 executes various methods and steps described above, such as the method of processing the image. For example, in some embodiments, the method of processing the image may be implemented as a computer software program which is tangibly embodied in a machine-readable medium, such as the storage unit 608. In some embodiments, the computer program may be partially or entirely loaded and/or installed in the electronic device 600 via the ROM 602 and/or the communication unit 609. The computer program, when loaded in the RAM 603 and executed by the computing unit 601, may execute one or more steps in the method of processing the image described above. Alternatively, in other embodiments, the computing unit 601 may be configured to perform the method of processing the image by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of processing an image, the method comprising:
generating a to-be-processed image according to a first target image and a second target image, wherein an identity information of an object in the to-be-processed image is matched with an identity information of an object in the first target image, and a texture information of the object in the to-be-processed image is matched with a texture information of an object in the second target image;
generating a set of disentangled images according to the second target image and the to-be-processed image, wherein the set of disentangled images comprises a head-disentangled image corresponding to a head region of the object in the to-be-processed image and a disentangled repair image corresponding to a to-be-repaired information related to the object in the to-be-processed image; and
generating a fusion image according to the set of disentangled images, wherein an identity information of an object in the fusion image and a texture information of the object in the fusion image are matched with the identity information of the object in the to-be-processed image and the texture information of the object in the to-be-processed image, respectively, and a to-be-repaired information related to the object in the fusion image is repaired.

2. The method according to claim 1, wherein the disentangled repair image comprises a first disentangled image and a second disentangled image, and
wherein an identity information of an object in the first disentangled image is matched with the identity information of the object in the to-be-processed image, and a skin color information of the object in the first disentangled image is matched with a skin color information of the object in the second target image, and
wherein the second disentangled image is a differential image between the head region of the object in the to-be-processed image and a head region of the object in the second target image, and
wherein the to-be-repaired information related to the object in the fusion image is repaired, indicating that: a skin color information of the object in the fusion image is matched with the skin color information of the object in the second target image, and a pixel value of a pixel in the differential image meets a preset condition.

3. The method according to claim 1, wherein the head-disentangled image comprises a third disentangled image, a fourth disentangled image and a fifth disentangled image, and
wherein the third disentangled image comprises a grayscale image of the head region of the object in the to-be-processed image,
wherein the fourth disentangled image comprises a binarized image of the head region of the object in the to-be-processed image, and
wherein the fifth disentangled image comprises an image obtained according to the second target image and the fourth disentangled image.

4. The method according to claim 1, wherein the generating a fusion image according to the set of disentangled images comprises processing the set of disentangled images by using a fusion model, so as to obtain the fusion image, wherein the fusion model comprises a generator in a first generative adversarial network model.

5. The method according to claim 4, wherein the fusion model is trained by using a first identity information loss function, a first image feature alignment loss function, a first discriminant feature alignment loss function and a first discriminator loss function.

6. The method according to claim 1, wherein the generating a to-be-processed image according to a first target image and a second target image comprises:
processing the first target image by using an identity extraction module in a driving model, so as to obtain the identity information of the object in the first target image;
processing the second target image by using a texture extraction module in the driving model, so as to obtain the texture information of the object in the second target image;
processing the identity information and the texture information by using a concatenating module in the driving model, so as to obtain a concatenated information; and
processing the concatenated information by using a generator in the driving model, so as to obtain the to-be-processed image.

7. The method according to claim 6, wherein a number of the concatenated information is multiple, the generator in the driving model comprises N depth units connected in cascade, wherein N is an integer greater than 1, and
wherein the processing the concatenated information by using a generator in the driving model so as to obtain the to-be-processed image comprises:
processing, for an i^{th} depth unit of the N depth units, an i^{th} level jump information corresponding to the i^{th} depth unit by using the i^{th} depth unit, so as to obtain an i^{th} level feature information, wherein the i^{th} level jump information comprises an (i−1)^{th} level feature information and an i^{th} level concatenated information, wherein i is greater than 1 and less than or equal to N; and
generating the to-be-processed image according to an N^{th} level feature information.

8. The method according to claim 6, wherein the driving model is trained by using a second identity information loss function, a second image feature alignment loss function, a second discriminant feature alignment loss function, a second discriminator loss function and a cycle consistency loss function.

9. The method according to claim 8, wherein the cycle consistency loss function is determined according to a predicted result generated by the driving model and a real result, and
wherein the real result comprises a real identity information of an object in a real image and a real texture information of the object in the real image, and the predicted result comprises a predicted identity information of an object in a simulated image and a predicted texture information of the object in the simulated image.

10. The method according to claim 1, further comprising performing an enhancement processing on the fusion image to obtain an enhanced image.

11.-17. (canceled)

18. An electronic device, comprising:
at least one processor; and
a memory communicatively connected to the at least one processor,
wherein the memory stores instructions executable by the at least one processor, and the instructions, when executed by the at least one processor, are configured to cause the at least one processor to implement at least the method of any claim 1.

19. A non-transitory computer-readable storage medium having computer instructions therein, wherein the computer instructions are configured to cause a computer system to implement at least the method of any claim 1.

20. (canceled)

21. The electronic device according to claim 18, wherein the disentangled repair image comprises a first disentangled image and a second disentangled image, and
wherein an identity information of an object in the first disentangled image is matched with the identity information of the object in the to-be-processed image, and a skin color information of the object in the first disentangled image is matched with a skin color information of the object in the second target image, and
wherein the second disentangled image is a differential image between the head region of the object in the to-be-processed image and a head region of the object in the second target image, and
wherein the to-be-repaired information related to the object in the fusion image is repaired, indicating that: a skin color information of the object in the fusion image is matched with the skin color information of the object in the second target image, and a pixel value of a pixel in the differential image meets a preset condition.

22. The electronic device according to claim 18, wherein the head-disentangled image comprises a third disentangled image, a fourth disentangled image and a fifth disentangled image, and
wherein the third disentangled image comprises a grayscale image of the head region of the object in the to-be-processed image,
wherein the fourth disentangled image comprises a binarized image of the head region of the object in the to-be-processed image, and
wherein the fifth disentangled image comprises an image obtained according to the second target image and the fourth disentangled image.

23. The electronic device according to claim 18, wherein the instructions are further configured to cause the at least one processor to at least process the set of disentangled images by using a fusion model, so as to obtain the fusion image, wherein the fusion model comprises a generator in a first generative adversarial network model.

24. The electronic device according to claim 23, wherein the fusion model is trained by using a first identity information loss function, a first image feature alignment loss function, a first discriminant feature alignment loss function and a first discriminator loss function.

25. The electronic device according to claim 18, wherein the instructions are further configured to cause the at least one processor to at least:
process the first target image by using an identity extraction module in a driving model, so as to obtain the identity information of the object in the first target image;
process the second target image by using a texture extraction module in the driving model, so as to obtain the texture information of the object in the second target image;
process the identity information and the texture information by using a concatenating module in the driving model, so as to obtain a concatenated information; and
process the concatenated information by using a generator in the driving model, so as to obtain the to-be-processed image.

26. The electronic device according to claim 25, wherein a number of the concatenated information is multiple, the generator in the driving model comprises N depth units connected in cascade, wherein N is an integer greater than 1, and
wherein the instructions are further configured to cause the at least one processor to at least:
process, for an i^{th} depth unit of the N depth units, an i^{th} level jump information corresponding to the i^{th} depth unit by using the i^{th} depth unit, so as to obtain an i^{th} level feature information, wherein the i^{th} level jump information comprises an (i−1)^{th} level feature information and an i^{th} level concatenated information, wherein i is greater than 1 and less than or equal to N; and
generate the to-be-processed image according to an N^{th} level feature information.

27. The electronic device according to claim 25, wherein the driving model is trained by using a second identity information loss function, a second image feature alignment loss function, a second discriminant feature alignment loss function, a second discriminator loss function and a cycle consistency loss function.

28. The electronic device according to claim 27, wherein the cycle consistency loss function is determined according to a predicted result generated by the driving model and a real result, and
wherein the real result comprises a real identity information of an object in a real image and a real texture information of the object in the real image, and the predicted result comprises a predicted identity information of an object in a simulated image and a predicted texture information of the object in the simulated image.
